(19) United States
(12) Patent Application Publication
(10) Pub. No.: US 2002/0145957 A1
(43) Pub. Date: Oct. 10, 2002

(54) File managing method for a recorded digital stream

(76) Inventor: Seog Yeon Han, Kyunggi-do (KR)

Correspondence Address: BIRCH STEWART KOLASCH & BIRCH, PO BOX 747, FALLS CHURCH, VA, 22040-0747, US

(21) Appl. No.: 09/731,848

(22) Filed: Dec. 8, 2000

(30) Foreign Application Priority Data
Dec. 10, 1999 (KR) 99-56725

(51) Int. Cl. G11B 7/004

(52) U.S. Cl. 369/47.12

(57) ABSTRACT

The present invention relates to a file management method of prohibiting copy of a file and change of a file name or a directory of a file which is recorded in a disk recording medium such as a rewritable digital versatile disk (DVD). The present file management method for a recorded digital stream according writes, in a writable disk, file describing information comprising file attributes for informing whether to prohibit renaming of file, directory change, or file copy, and determines whether to conduct a requested renaming of file, directory change, or file copy based on the written file attributes contained in the file describing information, thereby basically preventing disk reproduction fail caused by file or directory change of files containing A/V digital data stream as well as copyright infringement caused by copying the digital stream files recorded in a rewritable disk.

### BACKGROUND OF THE INVENTION

1. Field of the Invention

The present invention relates to a file management method of prohibiting copy of a file and change of a file name or a directory of a file which is recorded in a disk recording medium such as a rewritable digital versatile disk (DVD).

2. Description of the Related Art

FIG. 1 shows partial elements of an optical device such as a video disk recorder which recording and reproducing a signal to/from a disk recording medium such as a rewritable DVD. The device configured as FIG. 1 comprises an optical pickup 2 reading a signal recorded in a rewritable DVD 1 or writing a data stream processed into a writable signal in the rewritable DVD 1; a VDR unit 3 processing the read signal to restore to original data and converting an inputted data stream into a signal adequate to be written; and an encoder 4 encoding a received analog signal into a data stream which is sent to the VDR (Video Disk Recording) unit 3.

Disk file management method conducted by the optical device connected with a personal computer through a digital interface is explained referring to the accompanying drawings.

Various types of data files are recorded in the rewritable DVD 1 and the data files consist of data stream files and information files. The data stream files contain text data or real time audio and video (A/V) data of large size and the information files contain control information such as navigation data for the A/V or text data contained in the data stream files.

To manage recorded files, the rewritable DVD may adopt fixed file structure, which is adopted for a DVD ROM disk, composed of a root directory, several title set directories located under the root, and data files having different names and extension located under each title set directory.

FIG. 2 shows an example of such a fixed file structure in which a video title set directory under a root directory has several data files having different extension names.

Under the video title set directory, many files of ‘Video_TS.IFO’, ‘Video_TS.VOB’, ‘Video_TS.BUP’, ‘VTS_01_0.IFO’, ‘VTS_01_1.VOB’, ‘VTS_01_2.VOB’, and ‘VTS_01_0.BUP have been recorded. The file ‘Video_TS.IFO’ contains video data management information, the file ‘Video_TS.VOB’ contains menu data of a recorded video object (VOB), the file ‘Video_TS.BUP’ contains backup data for the video data management information, the file ‘VTS_01_0.IFO’ contains information on the first video title set, the file ‘VTS_01_1.VOB’ is the first video object containing A/V data belonging to the first video title set, the file ‘VTS_01_2.VOB’ is the second video object containing A/V data belonging to the first video title set, and the file ‘VTS_01_0.BUP’ contains backup information on the first video title set.

In addition, detailed information for each of the above files is written in a file identifier descriptor (FID) whose fields are shown in FIG. 3A. These fields are ‘Descriptor Tag’, ‘File Version Number’, ‘File Characteristics’, ‘Length of File Identifier’, ‘Information Control Block (ICB)’, ‘Length of Implementation Use’, ‘Implementation Use’, ‘Name of File Identifier’, and padding. Among these fields, ‘Name of File Identifier’ field is used for writing a string indicative of a file name, ‘Length of File Identifier’ field is used for writing size information of the file name, and ‘File Characteristics’ field, whose size is 1 byte, is used for writing various attributes of the file. The attributes written in ‘File Characteristics’ field are shown in FIG. 3B. The first LSB (Least Significant Bit) indicates whether an associated file exists or not, the second LSB indicates whether the file is directory or file, the third indicates deletion of the file, the fourth indicates whether the directory is parent or not, the fifth indicates meta data, and the remaining bits are reserved for future use.

If the first title set recorded in the rewritable DVD 1 having the above file structure is requested to be reproduced after the rewritable DVD 1 is inserted in the optical disk device of FIG. 1, the VDR unit 3 searches the DVD 1 for video title set directory under the root directory, and tries to read the several files under the video title set directory. To read data files and their management file belonging to the first video title set requested to be reproduced, the VDR unit 3 refers to information written in FID. The VDR unit 3 reads data files sequentially after searching them using navigation information written in the management file.

The disk device of FIG. 1 may be connected a personal computer (PC) through a digital interface, so that a user might request file name of the rewritable DVD 1 to be changed into a desirable name through the PC and the digital interface. In addition, a user might move files under a video title set directory to other directory.

Such changes of file name and directory might be directly conducted on the PC after the rewritable DVD 1 is placed in the PC.

However, the VDR unit 3 searches a rewritable DVD for pre-specified file names under pre-specified directory according to a playback-requested video title set, therefore, the VDR unit 3 could not determine which file to read so that it could not reproduce a playback-requested video title set, if the file or directory names were changed or files were moved to other directories.

Besides these problems, there is a problem that video title sets recorded in a rewritable DVD may be copied onto other storage device through a PC, which would cause to infringe a copyright of the video title sets.

### SUMMARY OF THE INVENTION

It is an object of the present invention to provide a file management method for a recorded digital stream which is able to prevent file name and directory of a rewritable disk recording medium from being changed as well as to prevent files recorded in the rewritable disk recording medium from being copied onto other storage device with a PC.

A file management method for a recorded digital stream according to the present invention writes, in a writable disk, file describing information comprising file attributes for informing whether to prohibit renaming of file, directory change, or file copy, and determines whether to conduct a requested renaming of file, directory change, or file copy based on the written file attributes contained in the file describing information.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 shows partial elements of an optical device such as a video disk recorder which recording and reproducing a signal to/from a disk recording medium such as a rewritable DVD;

FIG. 2 is an example of a fixed file structure;

FIGS. 3A and 3B show a format of file identifier descriptor and its attribute field, respectively;

FIG. 4 shows the attribute bit flags according to the present invention; and

FIGS. 5A and 5B are flow diagrams of a file management method for a recorded digital stream according to the present invention.

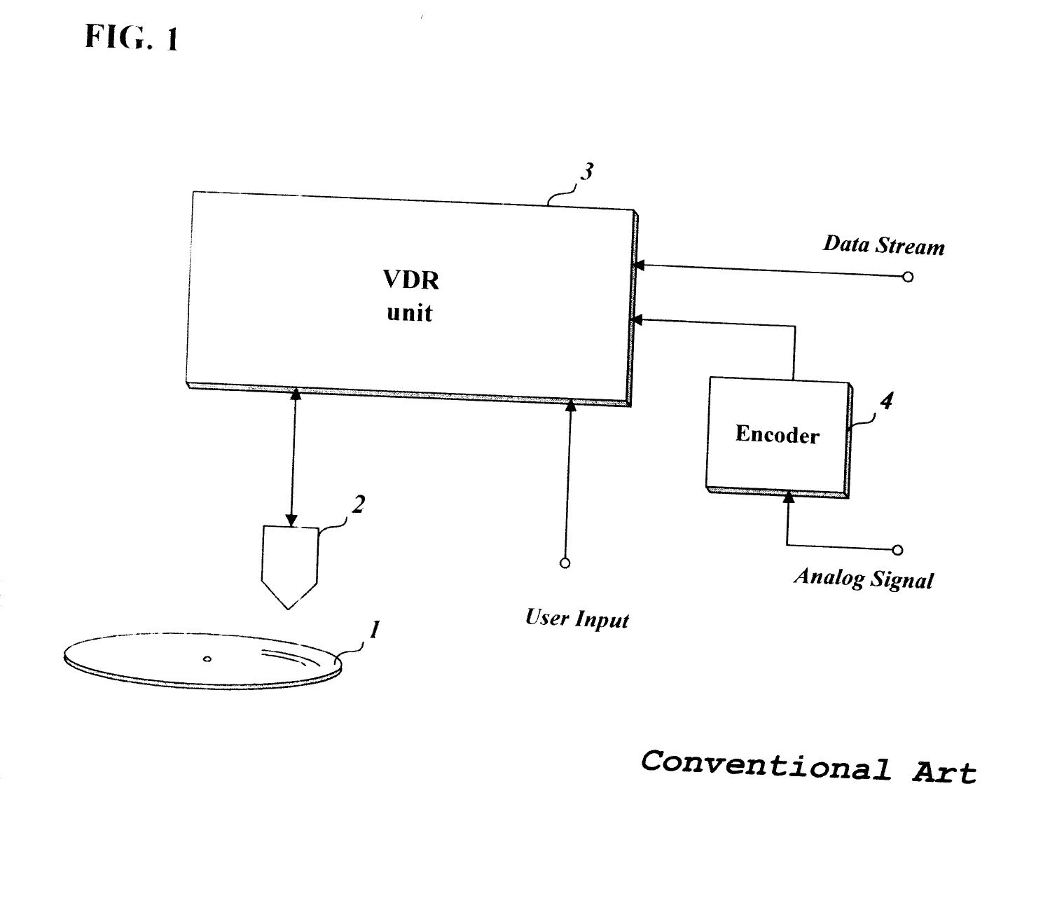

### DETAILED DESCRIPTION OF THE PREFERRED EMBODIMENT

In order that the invention may be fully understood, preferred embodiments thereof will now be described with reference to the accompanying drawings.

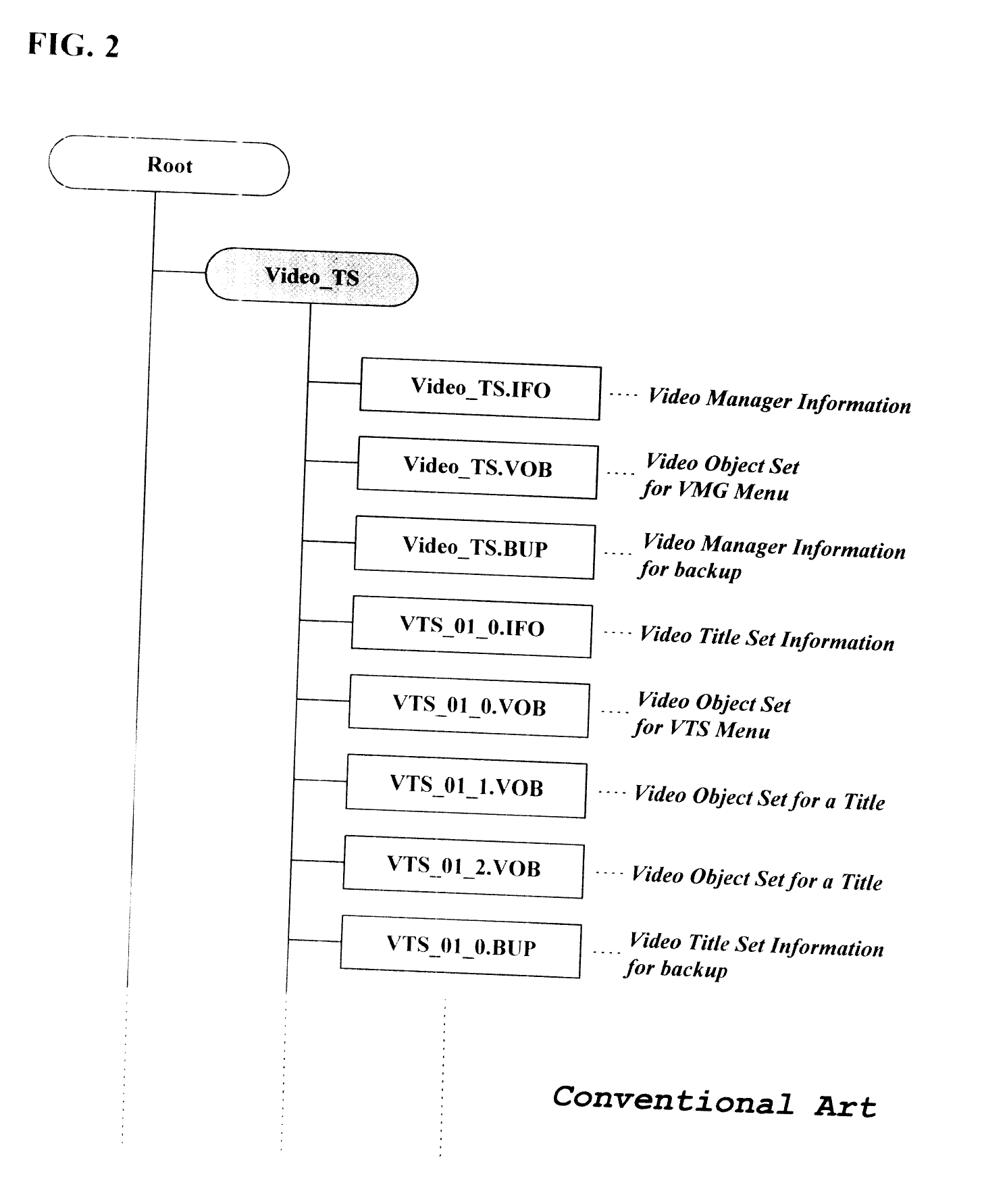

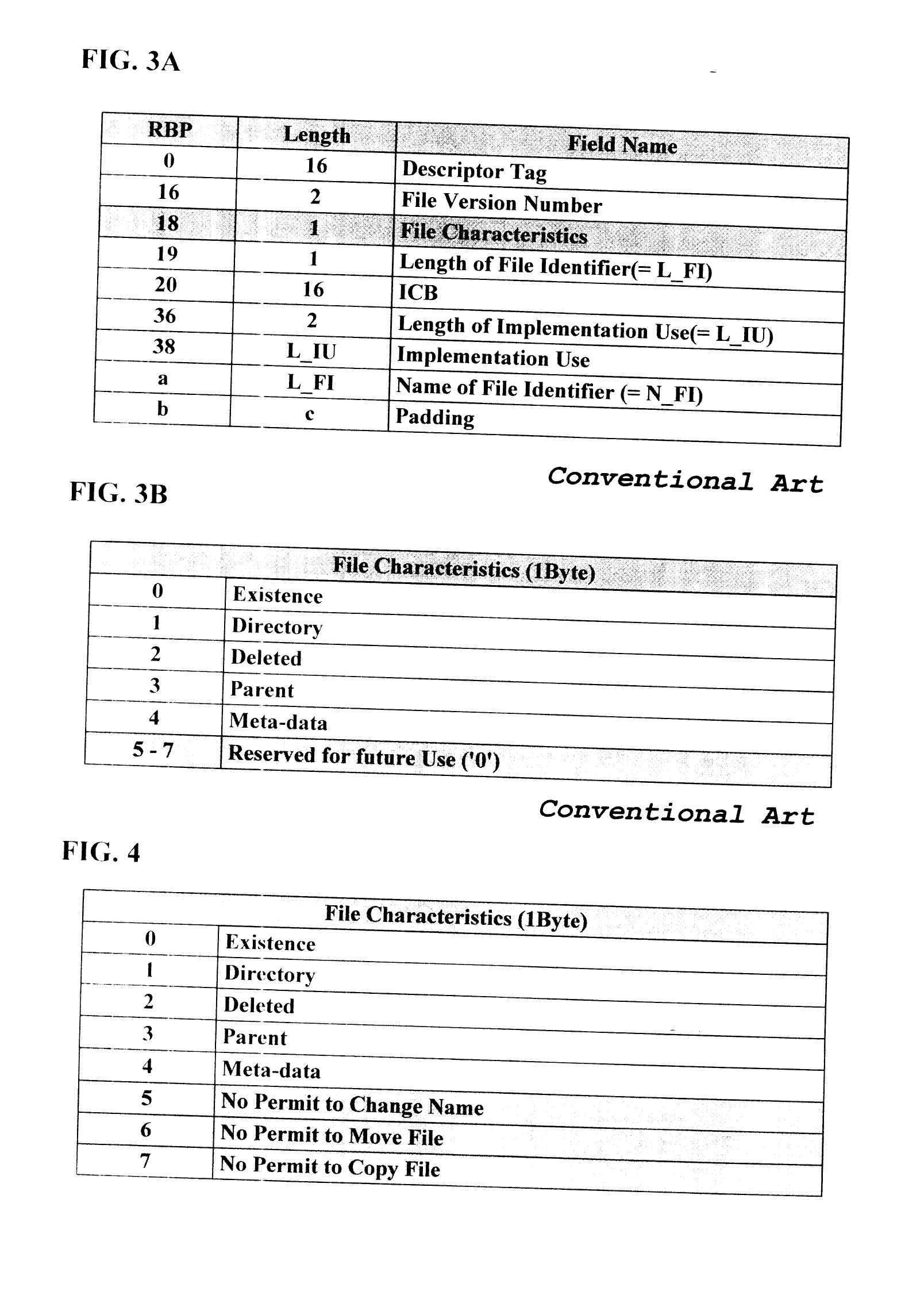

The file identifier descriptor written in a rewritable DVD according to the present invention is same structure as conventional one except internal attribute bits of its field of ‘File Characteristics’. That is, the file identifier descriptor, as shown in FIG. 3A, has fields of ‘Descriptor Tag’, ‘File Version Number’, ‘File Characteristics’, ‘Length of File Identifier’, ‘Information Control Block (ICB)’, ‘Length of Implementation Use’, ‘Implementation Use’, ‘Name of File Identifier’, and padding.

The attribute bit flags of the ‘File Characteristics’ field according to the present invention are shown in FIG. 4. The first LSB indicates whether an associated file exists or not, the second LSB indicates whether the file is directory or file, the third indicates deletion of the file, the fourth indicates whether the directory is parent or not, the fifth indicates meta data, the sixth indicates whether file name is changeable or not, the seventh indicates whether a file is movable or not, and the last indicates whether a file is allowed to be copied or not.

As shown in FIG. 4, the ‘File Characteristics’ field according to the present invention has additional bit flags of ‘No Permit to Change Name’, ‘No Permit to Move File’, and ‘No Permit to Copy File’ besides conventional attribute bits of ‘Existence’, ‘Directory’, ‘Deleted’, ‘Parent’, and ‘Meta Data’. The three ‘No Permit’ attribute bit flags are used as information to refer whenever a file is requested to rename, move, or copy or in a PC or from a PC to an optical disk device through a connecting digital bus.

The ‘No Permit to Change Name’ bit flag is used for determining whether to allow to rename an associated file, the ‘No Permit to Move File’ bit is used for determining whether to allow to change directory which an associated file belongs to, and the ‘No Permit to Copy File’ bit is used for determining whether to allow an associated file to be copied.

FIGS. 5A and 5B are flow diagrams of a file management method for a recorded digital stream according to the present invention. The flow diagrams of FIGS. 5A and 5B are conducted by an optical disk device configured as FIG. 2. The VDR unit 3 sets a interlinking operation mode (S10) in which file operation requested from a PC is acceptable if it is detected that the disk device has been connected with the PC through a digital interface. In this mode, if the PC requests a list of files under a certain directory recorded in the rewritable DVD 1 installed in the disk device (S11), the VDR unit 3 reads FIDs associated with files under the directory, and sends file names written in every fields of ‘Name of File Identifier’ to the PC (S12).

Accordingly, the PC displays the received file names onto its monitor, and a user may enter a command to rename, move, or copy a certain file after he or she looks into the displayed files and their directory. If a user enters such a command, the PC transmits the entered command to the disk device through a digital interface together with file identifying information.

Then, the VDR unit 3 of the disk device checks what the received command is. If the received command accompanying the file identifying information is for renaming a file (S14), the VDR unit 3 searches for the associated FID based on the file identifying information and checks the sixth bit ‘No Permit to Change Name’ written in the ‘File Characteristics’ field of the associated FID. If the sixth bit is 1 (S15) which means that change of filename is not permitted, the VDR unit 3 generates a message notifying that the requested file can not be renamed, and sends it to the PC (S17) through the digital interface.

If the received command is for moving a file (S18), the VDR unit 3 searches for the associated FID and checks the seventh bit ‘No Permit to Move File’ written in the ‘File Characteristics’ field of the associated FID. If the seventh bit is 1 (S19) which means that file moving is not permitted, the VDR unit 3 generates a message notifying that the requested file can not be moved to other directory, and sends it to the PC (S21).

In addition, if the received command is for moving a file (S22), the VDR unit 3 searches for the associated FID and checks the last bit ‘No Permit to Copy File’ written in the ‘File Characteristics’ field of the associated FID. If the last bit is 1 (S23) which means that file copy is not permitted, the VDR unit 3 generates a message notifying that the requested file can not be copied, and sends it to the PC (S25).

According to the above-explained operation, file renaming, file moving, or file copy is prohibited for files recorded in a rewritable disk, a user who requested file operation becomes aware that file operation requested for the files recorded in a rewritable disk has been prohibited through a corresponding message displayed onto monitor.

The digital stream file management method explained so far can basically prevent disk reproduction fail caused by file or directory change of files containing A/V digital data stream as well as copyright infringement caused by copying the digital stream files recorded in a rewritable disk.

Although the preferred embodiment of the present invention have been disclosed for illustrative purposes, those skilled in the art will appreciate that various modifications, additions and substitutions are possible, without departing from the scope and spirit of the invention as recited in the accompanying claims.

What is claimed is:

1. A file management method for files recorded in an optical disk, comprising the steps of:
(a) writing information on whether a digital stream file recorded in the optical disk is prohibited to be renamed or not; and
(b) determining whether to conduct a requested operation of file renaming based on the written information.

2. The method set forth in claim 1, wherein the information is written in the file attribute field of a file identifier descriptor in which detailed information on an associated file is written.

3. A file management method for files recorded in an optical disk, comprising the steps of:
(a) writing information on whether a digital stream file recorded in the optical disk is prohibited to be moved or not; and
(b) determining whether to conduct a requested operation of file moving based on the written information.

4. The method set forth in claim 3, wherein the information is written in the file attribute field of a file identifier descriptor in which detailed information on an associated file is written.

5. A file management method for files recorded in an optical disk, comprising the steps of:
(a) writing information on whether a digital stream file recorded in the optical disk is prohibited to be copied or not; and
(b) determining whether to conduct a requested operation of file copy based on the written information.

6. The method set forth in claim 5, wherein the information is written in the file attribute field of a file identifier descriptor in which detailed information on an associated file is written.

7. A file management method for files recorded in an optical disk, comprising the steps of:
(a) receiving a command for a file operation for a digital data stream file recorded in the optical disk;
(b) identifying the received command;
(c) checking whether the requested file operation for an associated file is prohibited or not based on pre-written attribute information for the associated file if the identified command indicates a file renaming, a file moving, or a file copy; and
(d) rejecting the file operation the command requested based on the checked result.

8. The method set forth in claim 7, wherein the command for a file operation is received from a computer through a digital interface.

9. The method set forth in claim 7, wherein said step (d) providing an outer device transmitted the command with information identifying of the rejection of the requested file operation.

10. A writable disk recording medium, comprising data files containing digital data stream and file descriptors for the data files, wherein each file descriptor has a file attribute field comprising flags for restricting file renaming and file moving.

11. The writable disk recording medium set forth in claim 10, wherein the file attribute field further comprising other flag for restricting file copy.
